(19) United States
(12) Patent Application Publication
(10) Pub. No.: US 2009/0153013 A1
(43) Pub. Date: Jun. 18, 2009

(54) ELECTRON-EMITTING DEVICE, ELECTRON SOURCE, IMAGE DISPLAY APPARATUS, AND METHOD FOR MANUFACTURING ELECTRON-EMITTING DEVICE

(75) Inventors: Michiyo Nishimura, Sagamihara-shi (JP); Ryoji Fujiwara, Chigasaki-shi (JP); Yoji Teramoto, Ebina-shi (JP); Kazushi Nomura, Sagamihara-shi (JP); Shunsuke Murakami, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/331,236

(22) Filed: Dec. 9, 2008

(30) Foreign Application Priority Data
Dec. 12, 2007 (JP) 2007-320639

(51) Int. Cl. H01J 1/02; H01J 9/02

(52) U.S. Cl. 313/311; 445/46

(57) ABSTRACT

A method for manufacturing an electron-emitting device according to the present invention includes a step of preparing a carbon layer containing conductive metallic particles, a step of oxidizing a portion the conductive metallic particles, and a step of forming a dipole layer on a surface of the carbon layer. An electron-emitting device according to the present invention is manufactured by the manufacturing method for the electron-emitting device. An electron source according to the present invention includes a plurality of the electron-emitting devices. An image display apparatus according to the present invention includes the electron source and a image forming member which forms an image by an electron emitted from the electron source.

### BACKGROUND OF THE INVENTION

1. Field of the Invention

The present invention relates to an electron-emitting device, an electron source, an image display apparatus, and a method for manufacturing an electron-emitting device.

2. Description of the Related Art

Conventionally, there has been a demand for an electron-emitting device for emitting an electron at a low electric field.

In order to obtain such an electron-emitting device, researches on an electron-emitting material and a configuration of an electron-emitting device have been conducted.

In detail, an electron-emitting material and a configuration of an electron-emitting device have been researched to increase an electric field reinforcement effect (effect for increasing an electric field) or to lower a work function.

As a method for increasing an electric field reinforcement effect, there are, for example, a method for using a sharp pointed end of metal as an electron-emitting material and a method for using a fibrous material with a pointed end diameter of nanometer order such as a so-called carbon nanotube. There is also an example for enforcing an electric field by using a portion that a local structure inside a crystal (electron-emitting material) and the like, other than an exterior shape of an electron-emitting material is changed.

Meanwhile, as a method for lowering a work function, there are a method for coating/adding a material with a low work function on/to an electron-emitting material and a method for using a negative electron affinity.

However, a desired electron-emission characteristic may not be obtained in an electron-emitting device manufactured by the above-mentioned methods. Also, due to restrictions described below, a method for manufacturing an electron-emitting device which shows a desired electron-emission characteristic has been limited.

An electron-emitting device which aims to lower a work function has a restriction to a manufacturing method due to instability of a material (crystal structure). Also, since it has to be stored under a vacuum until it is used, there is a restriction to it use.

Meanwhile, an electron-emitting device which aims to increase an electric field reinforcement effect has a possibility that restrictions to a manufacturing process is reduced, compared to that of an electron-emitting device which aims to lower a work function. However, in case of using an effect resulting from an exterior shape of an electron-emitting material, there is a need for research in order to keep a fine structure of a nanometer size from being transformed by an driven electric field or generated heat.

With respect to such restrictions, a carbon-based material has advantage when used as an electron-emitting material since it is excellent in heat resistance and can expect an electron emission at a low electric field. Also, since a carbon-based material mixed with metal is excellent in driving stability, it is promising as an electron-emitting material.

As an example of an electron-emitting device which uses a carbon-based electron-emitting material, electron-emitting devices which use a carbon-based electron-emitting material as a mother body material and an electron-emitting film containing conductive metal are disclosed in Japanese Patent Application Laid-Open (JP-A) Nos. 2004-71356 and 2001-6523.

Also, an example for coating conductive metal with an insulating layer in order to secure driving stability is disclosed in U.S. Pat. No. 6,097,139.

However, even in the technologies disclosed in above mentioned JP-A Nos. 2004-71356 and 2001-6523 and U.S. Pat. No. 6,097,139, manufacturing stability is not guaranteed.

For example, when an etching process is performed as one of a manufacturing process, conductive metal is also etched, and so there is a case where an electron-emitting device which shows a desired electron-emission characteristic cannot be obtained.

That is, in an electron-emitting device, it is important to use an electron-emitting material with a structure which is stable in manufacturing and driving.

### SUMMARY OF THE INVENTION

It is an object of the present invention to provide a method for manufacturing an electron-emitting device in which a manufacturing process is stable and an electron emission of high efficiency is stably performed at a low voltage. It is another object of the present invention to provide an electron-emitting device manufactured by the manufacturing method, an electron source formed by using the electron-emitting device, and an image display apparatus with high contrast which employs the electron source.

In order to achieve the above objects, a method for manufacturing an electron-emitting device according to the present invention includes a step of preparing a carbon layer containing conductive metallic particles, a step of oxidizing a portion of the conductive metallic particles, and a step of forming a dipole layer on a surface of the carbon layer.

Also, an electron-emitting device according to the present invention is manufactured by the manufacturing method.

Also, an electron source according to the present invention includes a plurality of the electron-emitting devices.

Also, an image display apparatus according to the present invention includes the electron source, and an image forming member for forming an image by an electron emitted from the electron source.

Accordingly, the present invention provides a method for manufacturing an electron-emitting device in which a manufacturing process is stable and an electron emission of high efficiency is stably performed at a low voltage. Also, the present invention provides an electron-emitting device manufactured by the manufacturing method, an electron source formed by using the electron-emitting device, and an image display apparatus with high contrast which employs the electron source.

Further features of the present invention will become apparent from the following description of exemplary embodiments with reference to the attached drawings.

### BRIEF DESCRIPTION OF THE DRAWINGS

FIGS. 1A to 1C are views illustrating one example of a method for manufacturing an electron-emitting device according to an embodiment of the present invention;

FIGS. 2A to 2C are views illustrating one example of the electron-emitting device according to an embodiment of the present invention, wherein FIG. 2A is a plane view, FIG. 2B is a cross-sectional view, and FIG. 2C is an enlarged cross-sectional view;

FIGS. 3A to 3F are views illustrating one example of the electron-emitting device according to an embodiment of the present invention;

FIGS. 4A to 4B are band diagrams illustrating the electron-emitting device according to an embodiment of the present invention;

FIG. 5 is a view illustrating an electron emitting principle of the electron-emitting device according to an embodiment of the present invention;

FIG. 6 is a view illustrating one example of an electron source according to an embodiment of the present invention;

FIG. 7 is a view illustrating one example of an electron source according to an embodiment of the present invention;

FIG. 8 is a view illustrating one example of an image display apparatus according to an embodiment of the present invention;

FIGS. 9A and 9B are views illustrating phosphors of the image display apparatus according to an embodiment of the present invention;

FIG. 10 is a view illustrating one example of a driving circuit of the image display apparatus according to an embodiment of the present invention;

FIG. 11A and 11B are views illustrating XPS spectra of metallic particles in the electron-emitting device according to an embodiment of the present invention; and

FIGS. 12A to 12F are views illustrating one example of a method for manufacturing the electron-emitting device according to an embodiment of the present invention.

### DESCRIPTION OF THE EMBODIMENTS

Hereinafter, exemplary embodiments of the present invention will be described in detail with reference to the drawings. However, a dimension, a material, a shape, and a relative arrangement of components described in the exemplary embodiments of the present invention are not intended to limit the scope of the present invention only to them unless otherwise stated.

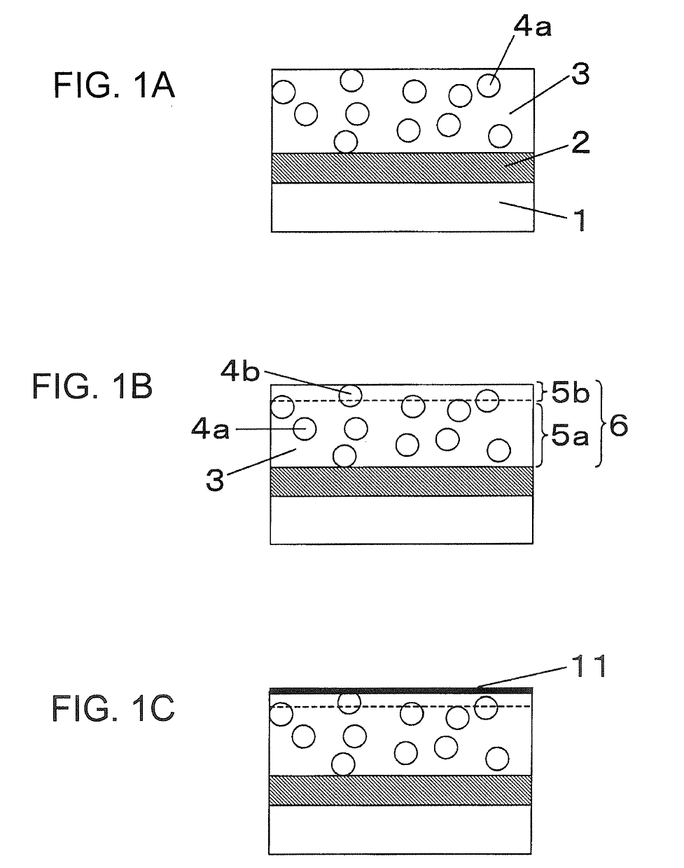

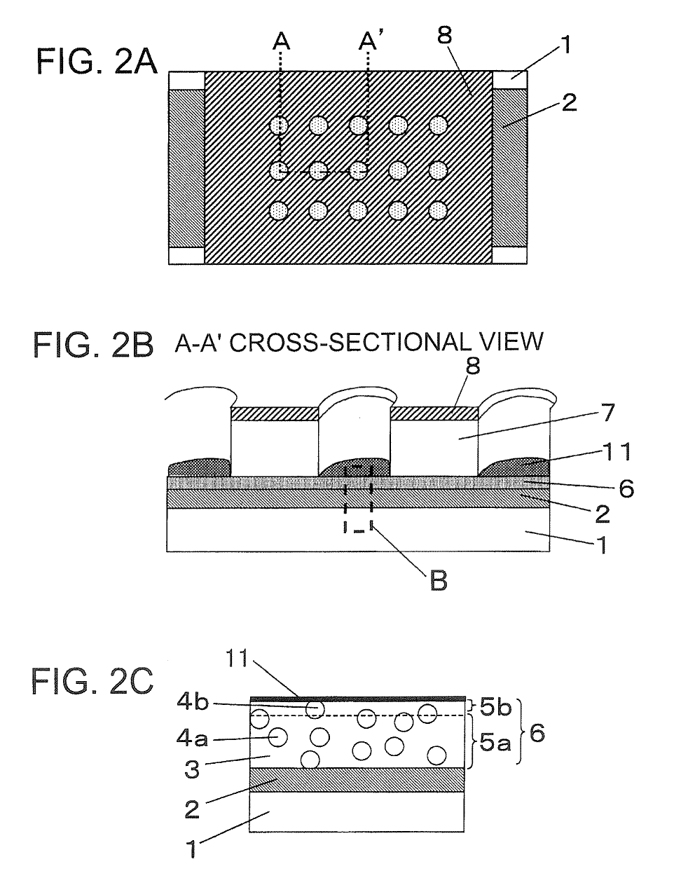

FIGS. 1A to 1C and FIG. 2C show one example of a method for manufacturing an electron-emitting device according to the present embodiment. In FIGS. 1 and 2C, reference numeral 1 denotes a substrate, reference numeral 2 denotes a cathode electrode, reference numeral 3 denotes a carbon layer, reference numeral 4a denotes a conductive metallic particle, reference numeral 4b denotes an oxidized metallic particle (in the present embodiment, only a surface of a metallic particle is oxidized), and reference numeral 11 denotes a dipole layer. Reference numeral 5a denotes a first layer composed of the conductive metallic particle 4a and the carbon layer 3, reference numeral 5b denotes a second layer composed of the oxidized metallic particle 4b and the carbon layer 3, and reference numeral 6 denotes an electron-emitting material composed of the first layer 5a, the second layer 5b and the dipole layer 11. The electron-emitting device of FIG. 1 has a multi-layer structure in which the substrate 1, the cathode electrode 2, and the electron-emitting material 6 are stacked in this described order.

The method for manufacturing the electron-emitting device according to the present embodiment includes processes shown in FIGS. 1A to 1C. A process of FIG. 1A is a process for preparing the carbon layer 3 containing the conductive metallic particles 4a therein. A process of FIG. 1B is a process for oxidizing some of the conductive metallic particles 4a. A process of FIG. 1C is a process for forming the dipole layer 11 on a surface of the carbon layer 3. A threshold electric field of the electron-emitting device (minimum electric field required to emit an electron) can be reduced by forming the dipole layer 11. The respective processes will be described in detail later.

FIGS. 2A to 2C show one example of the electron-emitting device according to the present embodiment. FIG. 2A is a plane view of the electron-emitting device which is shown from the top (side through which an electron is emitted), FIG. 2B is a cross-sectional view taken along line A-A′ of FIG. 2A, and FIG. 2C is an enlarged view illustrating a portion surrounded by a dotted line B of FIG. 2B.

For a structure of the electron-emitting device of FIG. 2, an insulating layer 7 and a gate electrode 8 are added to a structure of FIG. 1. The insulating layer 7 is formed between the cathode electrode 2 and the gate electrode 8. An opening is formed in each of the gate electrode 8 and the insulating layer 7 such that the gate electrode 8 and the insulating layer 7 are communicated with each other, and an electron emitting material 6 is exposed by the opening. As the opening of the gate electrode 8 and the insulating layer 7, a plurality of openings are formed in a single device. The electron-emitting device of FIG. 2 emits an electron by applying a voltage (driving voltage) between the cathode electrode 2 and the gate electrode 8. In case of employing the electron-emitting device in an electron source, an anode electrode (not shown) is usually formed at a location apart from the top of the device. That is, three terminals of the cathode electrode, the gate electrode and the anode electrode are typically used. An electron emitted from the device is accelerated by applying a high voltage to a corresponding anode electrode.

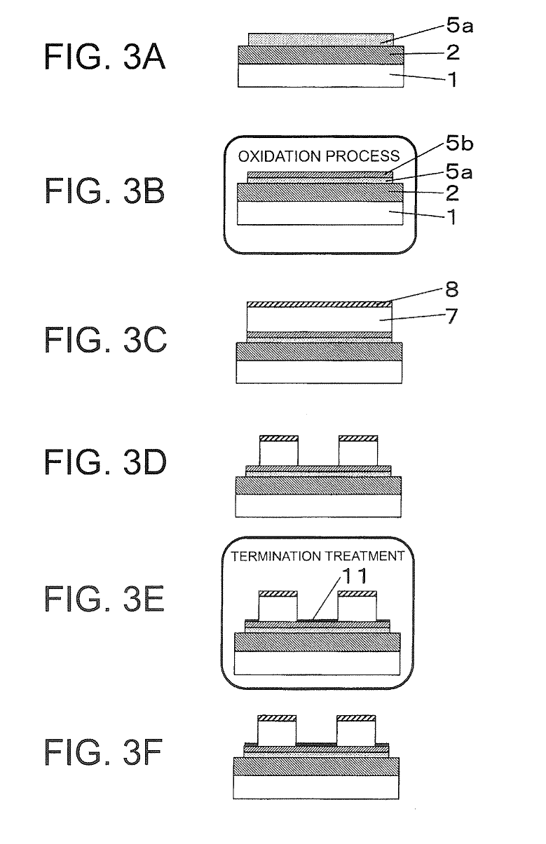

One example of the method for manufacturing the electron-emitting device according to the present embodiment will be described in detail with reference to FIGS. 1 and 3. However, this example is not intended to limit the scope of the present invention only to them unless otherwise stated.

(Process 1)

First, the cathode electrode 2 is formed on the substrate 1 whose surface is sufficiently cleaned. Then, the first layer 5a is deposited on a desired place (e.g., all areas on the cathode electrode). As the substrate 1, used is an insulating substrate made of quartz glass, glass in which the content of an impurity such as Na is reduced, blue plate glass, a laminated body in which SiO₂ is stacked on a surface of the substrate, or ceramic. The first layer 5a is the carbon layer 3 containing the conductive metallic particles 4 (FIG. 1a).

The cathode electrode 2 usually has electrical conductivity and is formed by a typical vacuum film forming method such as an evaporation method or a sputtering method and a photolithography technique. The cathode electrode 2 is made of a material appropriately selected from a group composed of metal, an alloy, carbide, boride, nitride, and a semiconductor. As metal, for example, Be, Mg, Ti, Zr, Hf, V, Nb, Ta, Mo, W, Al, Cu, Ni, Cr, Au, Pt, or Pd can be used. The thickness of the cathode electrode 2 is set in a range of 10 nm to 100 μm and is preferably selected in a range of 100 nm to 10 μm.

Part of an insulating silicon substrate which is doped to have electrical conductivity may be used as the cathode electrode 2. Also, as the cathode electrode 2, layers with different compositions may be stacked (multi-layer structure). In a case where the cathode electrode 2 has a multi-layer structure, the cathode electrode 2 may contain a high resistance layer.

The first layer 5a composed of the carbon layer 3 containing the conductive metallic particles 4a therein may be formed by various methods. For example, as a method for forming the first layer 5a by a single process, there are a co-sputtering method using carbon and metal and a method for using a material containing carbon in which metallic particles are dispersed. As a method for forming the first layer 5a by a plurality of processes, there are a method for introducing (injecting) metallic particles into a carbon layer previously formed and a method for dispersing metallic particles and then coating the metallic particles with a carbon layer. The conductive metallic particle maybe formed in a particle form in advance or during a manufacturing process. As a method for making a particle form, an annealing technique or a plasma irradiation technique may be used.

The conductive metallic particle 4a is metal for forming an oxide and is more desirable as it is more stable in the carbon layer 3. The metallic particle 4a may have any shape of a globe, an ellipsoid, and a polyhedron. In the size of the metallic particle, the width (diameter in case of globe) is preferably in a range of 2 nm to 200 nm and more preferably 4 nm to 40 nm (so-called fine particle) regardless of a shape. Also, the size of the metallic particle is preferably smaller than the thickness of the first layer 5a in the process 1.

The carbon layer 3 is formed by, for example, a typical evaporation technique, a sputtering method, a plasma chemical vapor deposition (CVD) method, or a hot filament (HF) CVD method.

Preferably, the carbon layer 3 is made of diamond-like carbon (DLC) or amorphous carbon. Particularly, DLC or amorphous carbon is preferable since they include sp³ carbon as a main component.

The resistance rate of the carbon layer 3 itself (excluding the metallic particles 4a) is preferably equal to or more than 1×10⁸ Ωcm and equal to or less than 1×10¹⁴ Ωcm (insulation resistivity).

The carbon layer 3 may be formed to cover the whole or partial surface of the metallic particle 4a. The carbon layer 3 may be formed such that its surface is planarized by covering the whole surface of the metallic particle 4a.

(Process 2)

Next, some of the conductive metallic particles 4a are oxidized (FIG. 3B). That is, due to this process, some of a plurality of metallic particles 4a are converted to the oxidized metallic particles 4b, and part of the first layer 5a is converted to the second layer 5b composed of the oxidized metallic particles 4b and the carbon layer 3 (FIG. 1B). In detail, some of the metallic particles 4a around the surface of the first layer 5a are oxidized, so that a portion around the surface of the first layer 5a is converted to the second layer 5b. Subsequent processes (processes 3 and 4) can be performed by oxidizing some of the metallic particles 4a around the surface of the first layer 5a. For example, resistance for etching is obtained by oxidizing the metallic particles 4a around the surface. Also, in a case where the metallic particle is made of catalyst metal, when the dipole layer is formed, the growth of a carbon fiber may be promoted from the metallic particles 4a around the surface, so that stability of the manufacturing process gets worse. In the present embodiment, the growth of the carbon fiber can be suppressed by oxidizing some (metallic particles 4a around the surface) of the metallic particles 4a, thereby improving stability of the manufacturing process. Compared to the metallic particle made of non-catalyst metal, the metallic particle made of catalyst metal shows more excellent electron-emission characteristic in the manufactured electron-emitting device. As the catalyst metal, for example, Ni, Pd, and Co may be used.

As a method for oxidizing the metallic particle 4a, the metallic particle 4a may be heated in the air, be plasma-treated in an atmosphere containing oxygen, or be exposed to the air. Oxidization of the metallic particle is influenced by differences in a kind of metal, crystallinity, particle diameter, and the quality of carbon (density and state) Also, if a heating temperature is excessively high or oxygen partial pressure is excessively high in plasma treatment, the oxidation process is excessively activated, which is undesirable. In detail, if the oxidation process is excessively activated, (1) the whole surface of the metallic particle is oxidized (or the thickness of the oxidized layer becomes thicker) or (2) the carbon layer around the metallic particle is destroyed by fire. As a result, the case (1) is undesirable because a characteristic as the electron-emitting device is deteriorated. The case (2) is undesirable because the metallic particle may be peeled from the carbon layer. The oxidizing method is appropriately selected in consideration of the above-mentioned points.

(Process 3)

Next, an insulating layer 7 is deposited on the second layer 5b, and a gate electrode 8 is deposited on the insulating layer 7 (FIG. 3C).

The insulating layer 7 is formed by using a typical vacuum film forming method such as a sputtering method, a CVD method, or a vacuum deposition technique. The thickness of the insulating layer 7 is set in a range of 50 nm to 5 μm and preferably in a range of 100 nm to 5 μm. As a material of the insulating layer 7, a material which has high voltage resistance and can stand high electric field such as SiO₂, SiN, Al₂O₃, and CaF is preferably used.

The gate electrode 8 has electrical conductivity like the cathode electrode 2 and is formed by a typical vacuum film forming method such as a deposition technique or a sputtering method. The gate electrode 8 may be made of a material appropriately selected from materials of the cathode electrode 2.

(Process 4)

Next, an opening is formed in the gate electrode 8 and the insulating layer 7 (FIG. 3D).

The opening is formed by using a photolithography technique. That is, the opening is formed such that a mask with an opening is arranged on a desired area (i.e., on the gate electrode), and then etching treatment such as dry- or wet-etching is performed to form the opening. After forming the opening, a mask is peeled or removed, and then cleaning is performed. Due to this process, a portion of the second layer 5b is exposed by the opening.

The width W of the opening is appropriately set in consideration of a material and resistance of each layer composed of the electron-emitting device, a work function and a driving voltage of the electron-emitting device, and a desired electron emitting beam shape. A distance between the gate electrode 8 and the cathode electrode 2 is preferably in a range of 50 nm to 5 μm.

(Process 5)

Next, a surface of the second layer 5b is terminated by hydrogen to form the dipole layer 11 (FIG. 3E).

As hydrogen terminating treatment, plasma treatment may be performed at a hydrogen atmosphere. As hydrogen terminating treatment by intervention of carbon, heat treatment may be performed in an atmosphere containing a hydrocarbon-based gas. A surface of the carbon layer 3 is chemically modified by hydrogen (terminated by hydrogen) by the plasma treatment or the heat treatment, so that the dipole layer 11 is formed (FIG. 1C). The heat treatment may be performed by heating in an atmosphere containing both hydrogen and a hydrocarbon-based gas. As a hydrocarbon-based gas, a chain hydrocarbon gas such as an acetylene gas, an ethylene gas, and a methane gas is preferably used.

Through the above-mentioned processes, the electron-emitting device of FIG. 3F is completed.

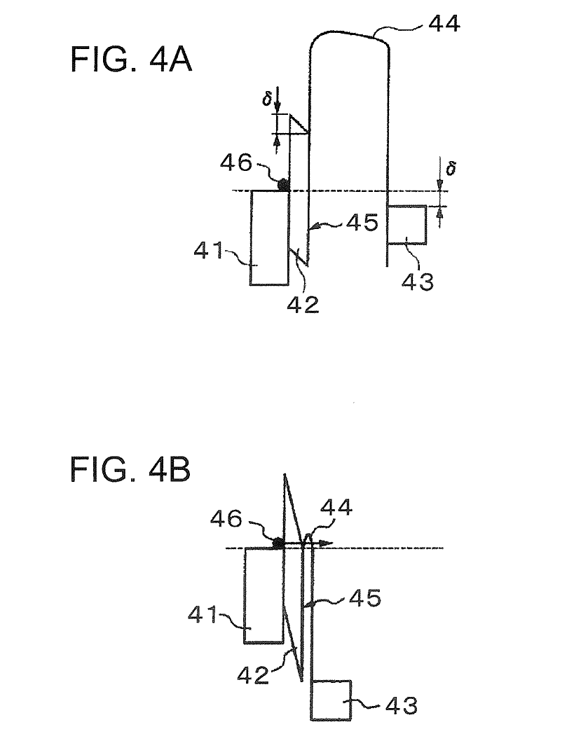

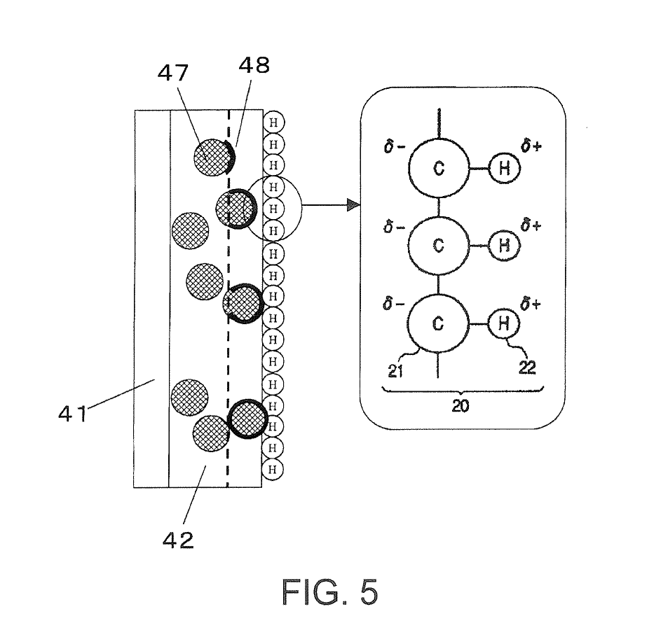

An electron emitting principle of the electron-emitting device according to the present embodiment will be described with reference to FIGS. 4 and 5.

In FIG. 4, reference numeral 41 denotes a cathode electrode, reference numeral 42 denotes an insulating area (carbon layer) on which the dipole layer 11 is formed, reference numeral 43 denotes an extraction electrode (gate electrode), reference numeral 44 denotes a vacuum barrier, reference numeral 45 denotes an interface between the insulating area 42 and the vacuum barrier 44, and reference numeral 46 denotes an electron.

A driving voltage for extracting an electron 46 into a vacuum from the cathode electrode 41 is a voltage between the cathode electrode 41 and the extraction electrode 43 when higher electric potential than electric potential of the cathode electrode 41 is applied to the extraction electrode 43.

FIG. 4A is a band diagram in which a driving voltage 0 [V] is applied to the electron-emitting device according to the present embodiment. FIG. 4B is a band diagram in which a driving voltage V [V] is applied to the electron-emitting device according to the present embodiment. In FIG. 4A, electric potential of the insulating area 42 has a state that a voltage of as much as 6 is applied since the dipole layer (polarization layer) is formed on its surface. When a voltage V [V] is applied to the electron-emitting device, a band of the insulating area 42 is more steeply bent, and the vacuum barrier 44 is also steeply bent. In this state (state that voltage V [V] is applied to the device), the vacuum barrier 44 contacting the dipole layer is higher than a conduction band of the surface of the insulating area 42 (FIG. 4B). When such a state comes, the electron 46 injected from the cathode electrode 41 tunnels the insulating area 42 and the vacuum barrier 44 to be emitted into a vacuum. Meanwhile, the driving voltage of the electron-emitting device according to the present embodiment is preferably equal to or less than 50 [V] and more preferably equal to or greater than 5 [V] and equal to or less than 50 [V].

A more detailed description will be given with reference to FIG. 5. In FIG. 5, reference numeral 41 denotes a cathode electrode, reference numeral 47 denotes a conductive metallic particle, and reference numeral 48 denotes an oxidized portion of the metallic particle. Reference numeral 20 denotes a dipole layer, reference numeral 21 denotes a carbon atom, and reference numeral 22 denotes a hydrogen atom.

The conductive metallic particle 47 electrically contacts the cathode electrode. Therefore, the metallic particle 47 may be interpreted as part of the cathode electrode 41. The cathode electrode 41 containing the metallic particle 47 contacts the insulating area 42. The dipole layer 20 is formed on the surface of the insulating area 42. A band structure of the insulating area 42 (FIG. 4) is determined by an area in which a spatial distance (film thickness) between the metallic particle 47 and the dipole layer 20 is narrowest.

In the electron-emitting device according to the present embodiment, the insulating area 42 may have any film thickness to the extent that an electron can tunnel through a sum of the thickness of the carbon layer coating the metallic particle 47 and the thickness of the oxidized portion 48 of the metallic particle. That is, if the oxidized portion 48 of the metallic particle has the electrically insulating property, the oxidized portion may be interpreted as part of the insulating area 42.

As described above, since the band structure of the insulating area 42 is strongly related to a spatial distance (minimum film thickness) of the insulating area 42 from the metallic particle 47 to the dipole layer 20, it is undesirable that the whole metallic particle 47 is oxidized. For this reason, it is desirable that only a topmost surface (1 nm to 5 nm) of the metallic particle is oxidized, and it is desirable that a portion of less than the particle diameter at maximum is oxidized.

Also, if the oxidized portion of the metallic particle has an electrical non-insulating property (semiconductor-like conduction), the carbon layer becomes the insulating area 42.

Also, the thickness of the insulating area 42 disposed between the metallic particle 47 and the dipole layer 20 can be determined according to the driving voltage and is preferably set to equal to or less than 20 nm and more preferably to equal to or less than 10 nm. The insulating area 42 disposed between the metallic particle 47 and the dipole layer 20 can have the minimum thickness to the extent that the barrier (vacuum barrier) which can be tunneled by the electron 46 is formed. But, the film thickness of the insulating area 42 is preferably set to equal to or greater than 1 nm in order to form a layer with excellent reproducibility.

Also, FIG. 5 shows that the dipole layer 20 is formed by terminating the surface (interface with a vacuum) of the carbon layer by using the hydrogen atom 22, but the dipole layer 20 according to the present invention is not limited to what is terminated by the hydrogen atom 22. Also, in the present embodiment, the insulating area 42 is formed of the carbon layer, but it is not limited to the carbon layer, and it may be formed of any material with the same band structure. However, in the present embodiment, the carbon layer is optimum for the sake of the stable manufacturing method.

As a material for terminating the surface of the insulating area 42, used is a material for lowering a surface level of the insulating area by equal to or greater than 0.5 eV and preferably equal to or greater than 1 eV in a state that a voltage is not applied between the cathode electrode 41 and the extraction electrode 43.

Also, in a case where the driving voltage is 0 [V] (off state), it is needed to completely cut off an electron emission.

Even though a voltage applied to a device through the gate electrode is 0, in case of a 3-terminal device, a voltage is continuously applied to an anode electrode. A voltage applied to the anode electrode is usually ten-odd kV to 30 kV. For this reason, a field strength formed between the anode electrode and the electron-emitting device is usually equal to or less than about 1×10⁵ [V/cm]. Therefore, it is desirable to prevent an electron from being emitted from the electron-emitting device due to the field strength. When the dipole layer is formed on the surface of the insulating area, the surface of the insulating area 42 has a positive electron affinity. The electron affinity (positive electron affinity) of the surface of the insulating area 42 is preferably equal to or greater than 2.5 [eV].

The dipolar layer 20 will be described in more detail. The present embodiment is described focusing on an example that the surface of the insulating area 42 is terminated by hydrogen atom 22. If the surface of the insulating area 42 is terminated by the hydrogen atom 22, the hydrogen atom 22 is very minutely polarized to a positive (δ⁺), and so the atom (carbon atom 21 in the present embodiment) of the surface of the insulating area is minutely polarized to a negative (δ⁻). Due to such a phenomenon, the dipole layer (electrical dual layer) 20 is formed.

As described above, the surface of the insulating layer of the electron-emitting device according to the present embodiment becomes an equivalent state to a state that electric potential δ [V] of the electrical dual layer is applied even though it is in a state that the driving voltage is not applied between the cathode electrode 41 and the extraction electrode 43, due to the corresponding dipole layer. Also, as shown in FIG. 4B, due to application of the driving voltage V [V] , the surface level of the insulating area 42 drops, and the spatial thickness of the insulating area 42 is also reduced. The level of the vacuum barrier 44 is also lowered, and the spatial thickness of the vacuum barrier 44 is also reduced. Due to such a phenomenon, the insulating area 42 and the vacuum barrier 44 become a state which can be tunneled, so that an electron is emitted into a vacuum.

In the electron-emitting device according to the present embodiment, the electron 46 tunnels the insulating area 42 and is then emitted into a vacuum. An area in which the film thickness of the insulating area 42 is minimum is an electron emitting point for emitting an electron at a lower voltage. Therefore, in a certain driving voltage, the electron emitting points discretely exist in the surface.

Generally, the electron emitting point density of the electron-emitting device is required to be as high as possible in order to reduce fluctuation. The electron emitting point density of the electron-emitting device according to the present embodiment is at least 1×10⁴ [number/mm²] and preferably equal to or greater than 1×10⁶ [number/mm²].

In the electron-emitting device according to the present embodiment, since it is easier to become the electron emitting point as the thickness of the insulating area 42 is thinner, a portion around an area in which the metallic particles exist can become the electron emitting point. For this reason, the number of the metallic particles is preferably at least 1×10⁴ [number/mm²] and more preferably equal to or greater than 1×10⁶ [number/mm²] . Also, the number of the metallic particles is preferably at least 1×10⁴ [number/mm²] (more preferably, equal to or greater than 1×10⁶ [number/mm²]) only in a desired area (an area for emitting an electron) of the insulating area 42.

The electron-emitting device according to the present embodiment can be implemented in various forms. For example, in the electron-emitting device according to the present embodiment, the shape of the cathode electrode 41 may be flat (film) and may have a protruding shape (e.g., conic shape) like a spindt shape in order to obtain the field-multiplication effect. The surface of the insulating area 42 containing the metallic particles 47 may be flat or may have a concave-convex shape of the same size as the metallic particle 47. However, in order to secure stability (process stability) required in manufacturing the electron-emitting device, the insulating area 42 is preferably a flat film.

<Application Example>

An application example of the electron-emitting device according to the present embodiment will be described below. For example, the electron-emitting device according to the present embodiment may constitute an electron source such that a plurality of electron-emitting devices are arranged on a base body. The electron source may be used to constitute an image forming apparatus.

The electron-emitting devices may be arranged in various forms. For example, a plurality of electron-emitting devices are arranged in an X direction and a Y direction in a matrix form. Electrodes of a plurality of electron-emitting devices arranged in the same row are commonly connected to a wiring of an X direction, and electrodes of a plurality of electron-emitting devices arranged in the same column are commonly connected to a wiring of a Y direction. This is referred to as a simple matrix arrangement. The simple matrix arrangement will be described below in detail.

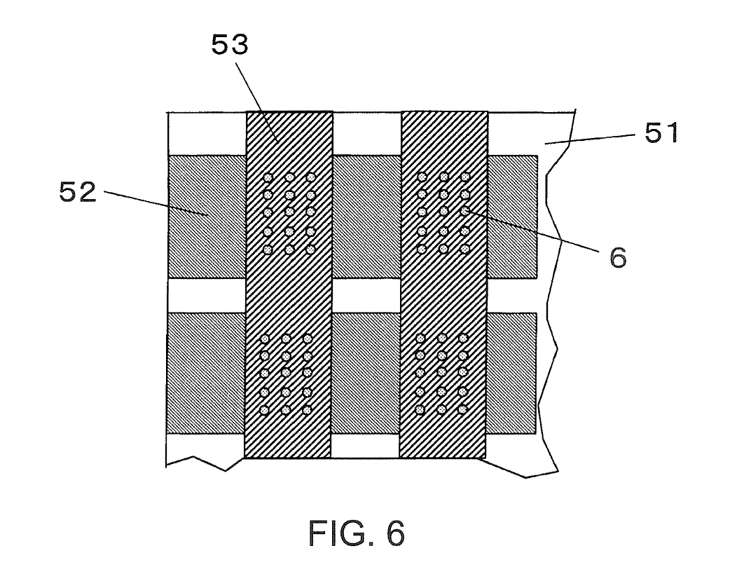

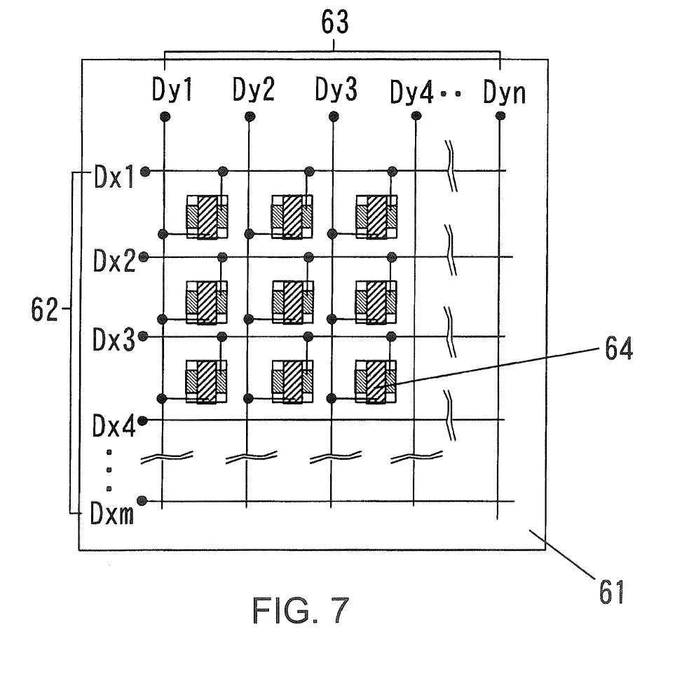

In FIGS. 6 and 7, reference numerals 51 and 61 denote an electron source base body, reference numerals 52 and 62 denote an X-direction wiring, reference numerals 53 and 63 denote a Y-direction wiring. Reference numeral 64 denotes the electron-emitting device according to the present embodiment.

The X-direction wiring 62 includes m wire liens Dx1, Dx2, . . . , Dxm and may be made of conductive metal and the like formed by a vacuum deposition technique, a printing technique or a sputtering method. A material, the film thickness, and the width of the wiring is appropriately designed. The Y-direction wiring 63 includes n wirings Dy1, Dy2, . . . , Dyn and is formed in the same method as the X-direction wiring 62. An interlayer insulating layer (not shown) is formed between the m X-direction wirings 62 and the n Y-direction wirings 63 which are electrically insulated from each other (m and n are a positive integer).

The interlayer insulating layer (not shown) is made of SiO₂ by using a vacuum deposition technique, a printing technique or a sputtering method. For example, it is formed in a desired form on the whole or partial area of the electron source base body 61 on which the X-direction wirings 62 is formed. Particularly, the film thickness, a material and a forming technique thereof is appropriately set to endure an electric potential difference of the crossing portion of the X-direction wiring 62 and the Y-direction wiring 63. The X-direction wiring 62 and the Y-direction wiring 63 extend as an external terminal, respectively.

The m X-direction wirings 62 which constitutes the electron-emitting device 64 may also function as the cathode electrode 2, and the n Y-direction wirings 63 may also function as the gate electrode 8, and the interlayer insulating layer may also function as the insulating layer 7.

Even though not shown, a scanning signal applying means is connected to the X-direction wiring 62. The scanning signal applying means applies a scanning signal to the electron-emitting device 64 connected to the selected X-direction wiring. Meanwhile, even though not shown, a modulation signal applying means is connected to the Y-direction wiring 63. The modulation signal applying means applies a modulation signal modulated according to an input signal to each column of the electron-emitting device 64. The driving voltage applied to each electron-emitting device is supplied as a difference voltage between the scanning signal and the modulation signal applied to the electron-emitting device.

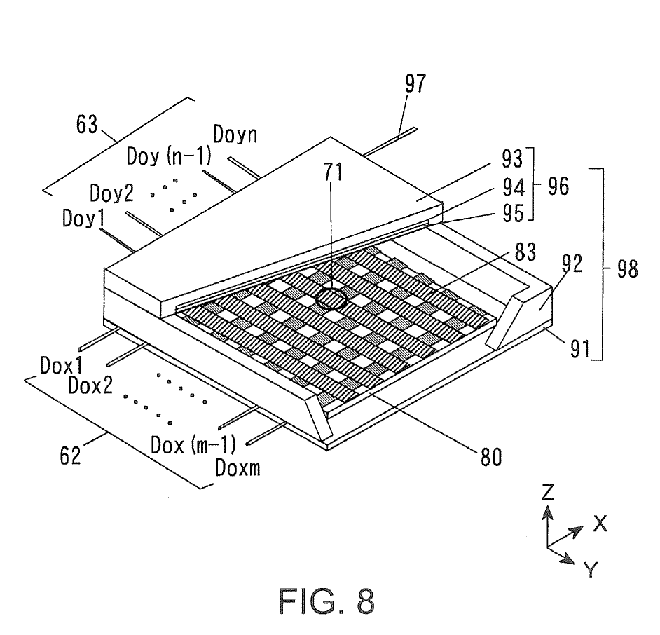

In the above-described method, the electron source having a plurality of electron-emitting devices according to the present embodiment can be manufactured. In the above-described configuration, it is possible to individually select and independently drive the electron-emitting devices by using the simple matrix wiring. An image display apparatus constituted by using the electron source will be described with reference to FIG. 8. FIG. 8 is a view illustrating one example of a display panel of an image display apparatus.

In FIG. 8, reference numeral 71 denotes an electron-emitting device, reference numeral 80 denotes an electron source substrate, reference numeral 91 denotes a rear plate, reference numeral 96 denotes a face plate, and reference numeral 92 denotes a support frame. A plurality of electron-emitting devices 71 are arranged on the electron source substrate 80, and the electron source substrate 80 is fixed to the rear plate 91. The face plate 96 includes a glass base body 93, a fluorescent film 94, and a metal back 95. The fluorescent film 94 and the metal back 95 are formed on an inner surface of the glass base body 93 (electron source side surface). In FIG. 8, the fluorescent film 94 is formed on the inner surface (inside surface) of the glass base body 93, and the metal back 95 is formed on an inner surface of the fluorescent film 94. The rear plate 91 and the face plate 96 are connected to the support frame 92 by using frit glass.

An external panel 98 includes the face plate 96, the support frame 92, and the rear plate 91. Since the rear plate 91 is usually formed to reinforce the strength of the electron source substrate 80, the separate rear plate 91 may not be needed when the electron source substrate 80 has the sufficient strength. In other words, the electron source substrate 80 and the rear plate 91 may be integrally formed.

The face plate 96, the rear plate 91 and the support plate 92 are bonded by coating frit glass on contact surfaces thereof, aligning and fixing them and heating them to fire the frit glass.

Also, as a means for such heating, various methods including, but not limited to, lamp heating using an infrared ray lamp or a hot plate may be employed.

A bonding material for heat-bonding a plurality of members which constitutes the external panel is not limited to frit glass, and may include various bonding materials which can maintain a sufficient vacuum state after the bonding process.

The external panel described above is one of the present embodiment, and the present invention is not limited to it and may employ various external panels.

Alternatively, the external panel 98 may include the face plate 96, the support frame 92 and the electron source substrate 80, wherein the support frame 92 is bonded directly to the electron source substrate 80. Besides, the external panel 98 having the sufficient strength to atmospheric pressure can be configured by installing a support body (not shown) called a spacer between the face plate 96 and the rear plate 91.

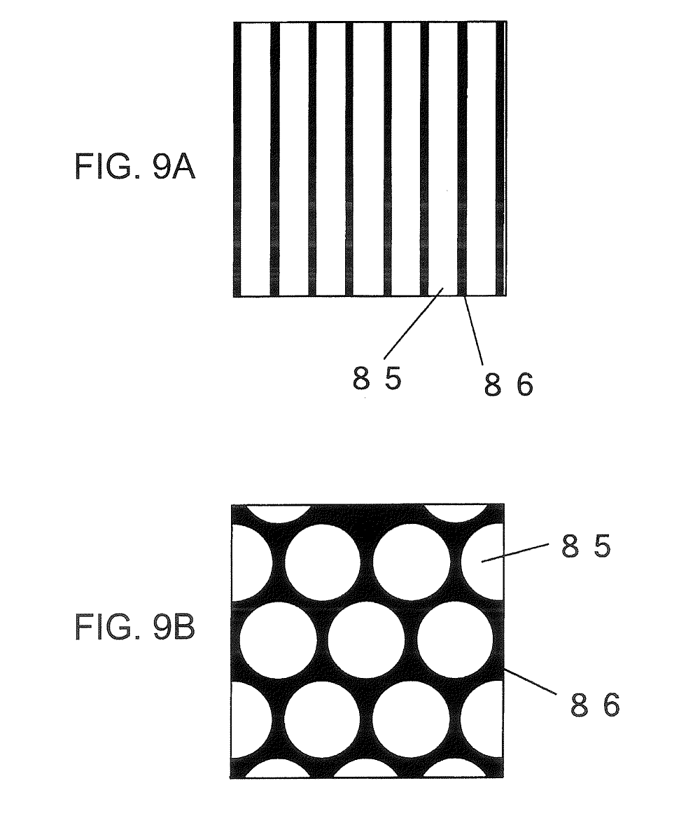

FIG. 9 is a view illustrating the fluorescent film 94 formed in the face plate 96. The fluorescent film 94 is an image forming member for forming an image by electrons emitted from the electron source. The fluorescent film 94 may include only a phosphor 85 in case of a monochrome. In case of a color fluorescent film, it may include a black conductive material 86 which is called a black stripe (FIG. 9A) or a black matrix (FIG. 9B) and a phosphor 85.

There are two purposes to form the black stripe or the black matrix. Firstly, in case of a color display, by making portions divided by coloring from respective phosphors 85 of three primary color phosphors black, a mixed color becomes indiscernible. Secondly, it is to suppress deterioration of the contrast due to ambient light in the fluorescent film 94. As a material of the black stripe, in addition to a material including graphite as a main component which is typically used, a conductive material which has low transmittance and low reflectivity may be used.

As a method for coating the phosphor on the glass base body 93, a deposition technique or a printing method may be used regardless of whether it is monochrome or color. The metal back 95 is typically formed on the inner side (electron source side surface) of the florescent layer 94. There are three purposes to form the metal back. One is to improve, brightness by specular-reflecting light directed to an inner surface side among light of the phosphor toward the face plate 96. Another is to use it as an electrode for applying an electro beam accelerating voltage, and the other is to protect the fluorescent film 94 from a damage caused by an impact of a negative ion generated in the external panel. The metal back 95 may be formed such that after the fluorescent film is formed, the inner surface of the fluorescent film is subjected to smoothing treatment (usually, called “filming”), and thereafter Al is deposited by a vacuum deposition.

A transparent electrode (not shown) may be formed on an external surface side (external side surface; glass substrate side) of the fluorescent film 94 in order to increase conductivity of the florescent layer 94 in a face plate 96.

In the image display apparatus according to the present embodiment, the fluorescent film 94 is disposed directly above the electron-emitting device 71 so that the electron-emitting device 71 can emit an electron beam directly upwardly.

Next, a vacuum sealing process for vacuum-sealing the external panel which has undergone the bonding process will be described.

The vacuum sealing process is performed such that the external panel 98 is heated to be maintained at a temperature of 80° C. to 250° C., and the ventilation is performed through an exhaust pipe (not shown) by an exhausting device such as an ion pump or a sorption pump. After an atmosphere in which organic materials are sufficiently small is formed, the exhaust pipe is heated by a burner to melt and completely seal. Getter processing may be performed in order to keep pressure of after sealing of the external panel 98. It is treatment for heating a getter disposed at a predetermined location (not shown) in the external panel 98 by heating using resistance heating or high frequency heating and forming a deposition film, directly before vacuum-sealing the external panel 98 or after sealing the external panel. The getter typically includes Ba as a main component and maintains an atmosphere inside the external panel 98 by adsorption of the deposition layer.

The image display apparatus manufactured by the above-described process applies a voltage to each electron-emitting device through external terminals Dox1 to Doxm and Doy1 to Doyn. As a result, electrons are emitted from the electron-emitting device.

An electron beam is accelerated by applying a high voltage to the metal back 95 or the transparent electrode (not shown) through a high voltage terminal 97.

The accelerated electrons crash into the fluorescent film 94. As a result, the fluorescent film 94 emits light, thereby forming an image.

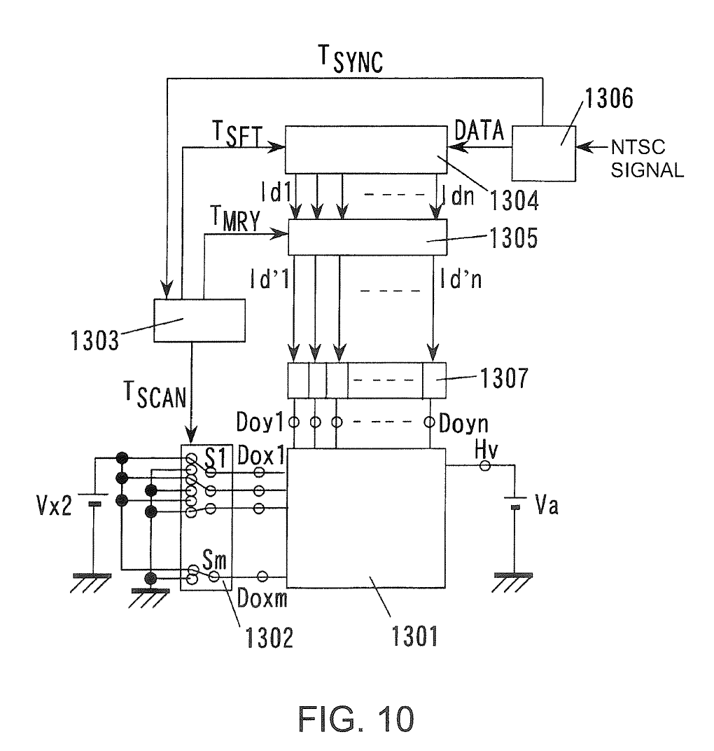

FIG. 10 is a block diagram illustrating one example of a driving circuit for displaying an image according to a television signal of an NTSC system.

The driving circuit of FIG. 10 will be described. This circuit has m switching devices (in the drawing, denoted by S1 to Sm) therein. Each switching device selects either an output voltage of a DC voltage source Vx1 or a DC voltage source Vx2 to be electrically connected to the external terminals Dox1 to Doxm of a display panel 1301. Each of the switching devices S1 to Sm operates in response to a control signal Tscan outputted from a control circuit 1303 and may include a combination of a switching device such as a field effect transistor (FET). The DC voltage source Vx1 is set based on a characteristic of the electron-emitting device.

The control circuit 1303 has a function for matching operations of respective components so that an appropriate display is performed based on an image signal externally inputted. The control circuit 1303 generates control signals Tscan, Tsft and Tmry to respective components based on a synchronizing signal Tsync transmitted from a synchronizing signal separator circuit 1306.

The synchronizing signal separator circuit 1306 is a circuit for separating the synchronizing signal component and a brightness signal component from a television signal (NTSC signal) of an NTSC system externally inputted and may include a general frequency separator (filter) circuit. The synchronizing signal separated from the NTSC signal by the synchronizing signal separator circuit 1306 includes a vertical synchronizing signal and a horizontal synchronizing signal and is denoted by Tsync for convenience. The brightness signal component of an image separated from the NTSC signal is denoted by DATA signal for convenience. The DATA signal is inputted to a shift register 1304.

The shift register 1304 is to serial/parallel convert the DATA signal, which is time-serially inputted, per one line of an image and performs a conversion based on the control signal Tsft transmitted from the control circuit 1303. That is, the control signal Tsft may be a shift clock of the shift register 1304. Data corresponding to one line (corresponding to driving data of N electron-emitting devices) of a serial/parallel-converted image is outputted as N parallel signals Id1 to Idn to be inputted to a line memory 1305.

The line memory 1305 is a memory unit for storing data corresponding to one line image during a necessary time and appropriately stores contents of Id1 to Idn according to the control signal Tmry transmitted from the control circuit 1303. The stored contents are outputted as Id′1 to Id′n to be inputted to a modulating signal generator 1307.

The modulation signal generator 1307 is a signal source of a modulation signal for appropriately driving-modulating each electron-emitting device of according to each of the image data Id′1 to Id′n. A signal outputted from the modulation signal generator 1307 passes through the terminals Doy1 to Doyn to be applied to the electron-emitting device in the display panel 1301.

When a voltage of a pulse form is applied to the electron-emitting device according to the present invention, for example, even though a voltage equal to or less than an electron emitting voltage (voltage required to emit an electron) is applied, an electron emission does not occur, but when a voltage equal to or greater than an electron emitting voltage is applied, an electron beam is outputted. At that time, the strength of the outputted electron beam can be controlled by changing a wave height value Vm of a pulse. Also, the total charge quantity of the outputted electron beam can be controlled by changing the width Pw of a pulse.

Therefore, as a method for modulating the electron-emitting device according to the input signal, a voltage modulation method and a pulse width modulation method and the like may be employed.

In executing the voltage modulation method, a circuit of the voltage modulation method which generates a voltage pulse of the predetermined length and appropriately modulates a wave height value of a pulse according to inputted data may be used as the modulation signal generator 1307.

In executing the pulse width modulation method, a circuit of the pulse width modulation method which generates a voltage pulse of a predetermined wave height value and appropriately modulates the width of the voltage pulse according to inputted data may be used as the modulation signal generator 1307.

As the shift register 1304 or the line memory 1305, a digital signal type or an analog signal type maybe employed. It is because a serial/parallel conversion or storing of the image signal has only to be performed at a predetermined speed.

In case of using the digital signal type, the output signal DATA of the synchronizing signal separator circuit 1306 needs to be converted into a digital signal, and so an A/D converter is located at an output of the synchronizing signal separator circuit 1306. In this regard, a circuit used in the modulation signal generator 1307 may become different a little depending on whether the output signal of the line memory 1305 is a digital signal or an analog signal. In detail, in case of the voltage modulation method using the digital signal, in the modulation signal generator 1307, for example, an D/A converting circuit is used, and an amplifying circuit is added if needed. In case of the pulse width modulation method, in the modulation signal generator 1307, for example, used is a circuit in which a high speed oscillator, a counter for counting the number of waves outputted from the corresponding oscillator, and a comparator for comparing an output value of the counter and an output value of the line memory are combined. If needed, an amplifier for amplifying the pulse width-modulated modulation signal, which is outputted from the comparator, up to the driving voltage of the electron-emitting device according to the present embodiment may be added.

In case of the voltage modulation method using the analog signal, in the modulation signal generator 1307, for example, an amplifying circuit using an operational amplifier may be used, and a level shift circuit may be added if needed. In case of the pulse width modulation method, for example, a voltage controlled oscillator (VCO) may be employed, and an amplifier for amplifying the modulation signal up to the driving voltage of the electron-emitting device according to the present embodiment may be added if needed.

The above-described configuration of the image forming apparatus is one example of the image forming apparatus to which the present invention can be applied and can be variously modified based on a technical thought of the present invention. For example, the input signal according to the present embodiment is a signal of the NTSC system and is not limited to it but may employ not only a PAL method and a SECAM method but also a TV signal method (e.g., high quality TV including a MUSE method) which has more scan lines than them.

Besides the display device, an optical printer constituted by using a photosensitive drum may be used as the image forming apparatus.

Embodiments of the present invention will be described in detail.

### Embodiment 1

An embodiment 1 will be described in detail with reference to FIG. 3 as one example of the method for manufacturing the electron-emitting device. Two electron-emitting devices (electron-emitting devices manufactured by comparison examples 1 and 2) are manufactured to compare to the electron-emitting device manufactured in the embodiment 1. The comparison example 1 is one which does not perform the process 2 (FIG. 3B), and the comparison example 2 is one which does not perform the process 5 (FIG. 3E).

(Process 1)

First, a glass substrate (PD200: available from Asahi Glass CO., Ltd) was used as a substrate 1 and is sufficiently cleaned. Then, a cathode electrode 2 made of TiN was formed at the thickness of 500 nm by using a sputtering method.

Next, a DLC layer was formed on the cathode electrode 2 at the thickness of 50 nm by using a HF-CVD method. A film forming condition is as follows:
Gas: CH₄
Gas pressure: 300 mPa
Substrate temperature: room temperature
Substrate bias: −50 V

A cobalt ion was doped into the DLC layer by using an ion doping technique. Ion doping was performed twice, at an accelerating voltage of 10 keV and an accelerating voltage of 30 keV, respectively. Both of doping processing was performed under a condition that the dose amount is 5×10¹⁶ number/cm².

Next, the substrate 1 with the cathode electrode 2 and the DLC layer containing a cobalt ion was annealed in a vacuum at a temperature of 400° C. for one hour.

A surface of the DLC layer was observed by a transmission electron microscope. As a result, it was observed that the DLC layer contained cobalt particles whose average diameter is 4.5 nm over the whole area, although a large or small density distribution was shown in the film thickness of 50 nm.

(Process 2)

Subsequently, the substrate was heated in a firing furnace at an air atmosphere at a temperature of 250° C. for ten minutes. Since if it was heated at a temperature of 300° C., the thickness of a portion of the DLC layer around the metallic particles would be reduced, a condition of a temperature of 250° C. and ten minutes was selected.

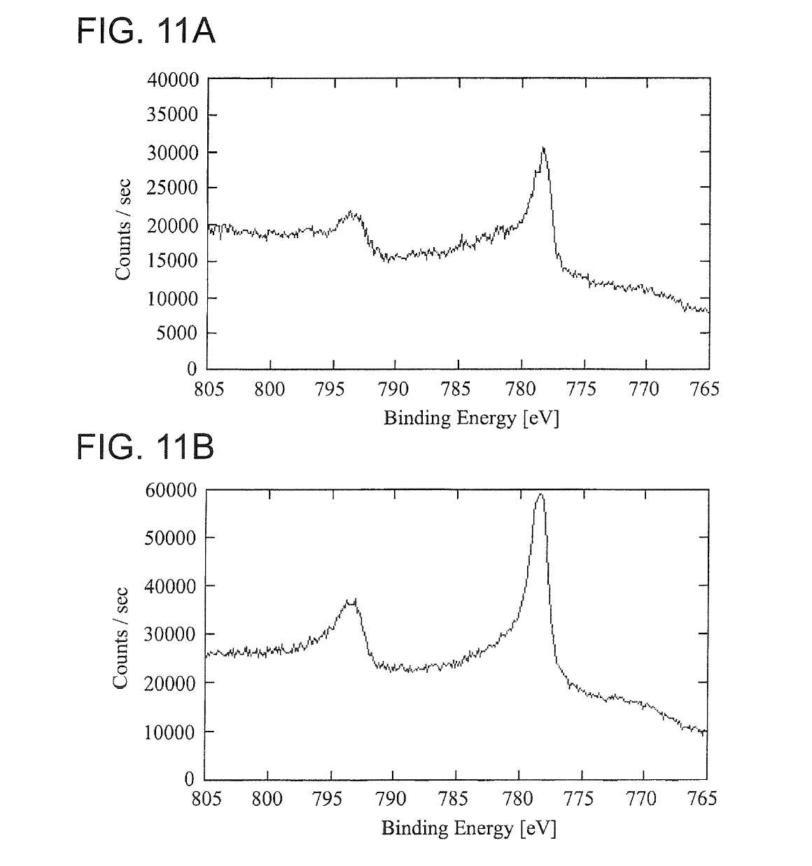

A surface of the DLC layer was analyzed by an XPS method to observe a chemical bond state of cobalt. FIG. 11A shows a bond state of a topmost surface, and FIG. 11B shows a bond state of the layer inside measured after shaving a surface by 5 nm through Ar sputtering.

A horizontal axis of FIG. 11 denotes binding energy (eV), and a vertical axis denotes a count value per second measured. By this measurement, chemical states of a topmost surface and a range of about 5 nm depth from a topmost surface were measured. Two peaks in the drawings are peaks of 2p 3/2 (778.8 eV) of Co and 2p 1/2 (793. eV) of Co, respectively. A change of the chemical state is measured as an energy shift of each peak. A change of from metal to a metal oxide is measured as a peak shift to a high bonding energy side. Theoretically, 2p 3/2 of Co is 778.8 eV in Co metal but 780 eV in CoO.

In FIG. 11A, a peak is broad. It is suggested that the reason is because a peak of CoO as well as a peak of Co is contained. In FIG. 11B, it is suggested that a peak is sharp and so a peak of Co metal is dominant.

(Process 3)

Next, Sio₂ is deposited on the DLC layer at the thickness of 1 μm as an insulating layer 7. Pt is deposited on the insulating layer 7 at the thickness of 200 nm as a gate electrode 8.

(Process 4)

Next, a mask pattern of a resist was formed by using a photolithography technique. The gate electrode 8 made of Pt was etched by Ar plasma etching, and the insulating layer 7 made of SiO₂ was etched by dry etching using a CF₄ gas. After etching, the mask pattern was peeled, and cleaning was sufficiently performed.

(Process 5)

Next, the device obtained through the processes 1 to 4 was subjected to heat treatment in an atmosphere of a methane-hydrogen mixed gas, so that a dipole layer 20 is formed. A heat treatment condition is as follows:
Heat treatment temperature: 600° C.
Heating method: lamp heating
Treatment time: 60 min
Mixed gas ratio: methane/hydrogen=15/6
Heat treatment pressure: 6 kPa

The electron-emitting device of the embodiment 1 was manufactured through the above-described processes. Also, the electron-emitting devices of the comparison examples 1 and 2 were manufactured at the same time.

A characteristic of the electron-emitting device of the embodiment 1 and characteristics of the electron-emitting devices of the comparison examples 1 and 2 were measured. The measurement was performed such that the electron-emitting device was arranged in a vacuum device, an anode electrode (not shown) was arranged at a location apart from and above the device opposite to the device, and a driving voltage was applied between the gate electrode and the cathode electrode.

The electron-emitting device of the embodiment 1 showed an excellent electron-emission characteristic. In detail, the corresponding electron-emitting device had a clear threshold electric field (electron emitting voltage) and emitted an electron at the low electric field strength. Such an electron-emission characteristic (excellent electron-emission characteristic) was confirmed in all of a plurality of electron-emitting devices manufactured by the manufacturing method for the embodiment 1.

On the contrary, in a plurality of electron-emitting devices manufactured by the manufacturing method for the comparison example 2, mixed were an electron-emitting device which emitted an electron directly after driving and an electron-emitting device which did not emit an electron at all. It was understood that the device which did not emit an electron did not emit an electron (electron-emission characteristic is bad) because the dipole layer was not formed.

The electron-emitting device of the embodiment 1 was compared to the electron-emitting device of the comparison example 1. In the manufacturing method for the comparison example 1, an electron-emitting device which shows the same characteristic could be more stably manufactured than the manufacturing method for the comparison example 2. However, the electron-emitting device of the comparison example 1 was worse in electron-emission characteristic than the electron-emitting device of the embodiment 1. As a result for identifying the reason, the electron-emitting device of the comparison example 1 was lower in cobalt density on surface than the electron-emitting device of the embodiment 1. As a result of identifying the process that cobalt was reduced, it was found that the density was reduced when peeling of the resist was performed in the process 4. It is suggested that it is because cobalt metal was eluted to a peeling solution.

As a result of observing the beam diameter of the electron-emitting device of the comparison example 1, the beam was widened. Also, the growth of a fiber-like shape existed in the electron-emitting device. Some of a plurality of electron-emitting devices did not emit an electron during driving. It is suggested that it is because the fiber was moved or deteriorated. For example, it is suggested that it did not drive because the fiber was torn during driving.

It is suggested that the fiber-like shape is a carbon fiber. It is suggested that the carbon fiber was generated and grown from some of metallic particles (a portion nearer to a surface of the DLC layer; singular point) which exist around the surface of the DLC layer by performing termination treatment (Process 5).

It is suggested that the growth of the carbon fiber did not occur in one which has undergone the oxidation process (Process 2) because such a singular point was selectively oxidized. It is suggested that the dipole layer on the surface of the DLC layer was stabilized to driving because the growth of the carbon fiber did not occur.

Since the manufacturing method for the embodiment 1 contains a process for exposing metal to an oxidation atmosphere, stability for subsequent processes is secured. As a result, the electron-emitting device with a desired electron-emission characteristic can be stably manufactured.

### Embodiment 2

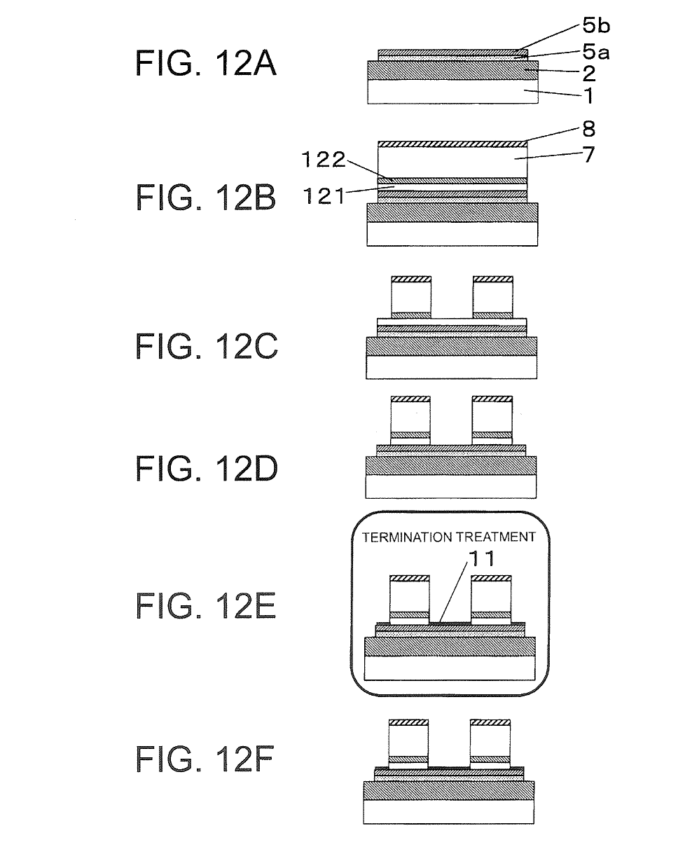

The embodiment 2 will be described in detail with reference to FIG. 12 as another example of the method for manufacturing the electron-emitting device. The electron-emitting device manufactured in the embodiment 2 is an electron-emitting device in which a passivation layer is formed on a cathode electrode and a second cathode electrode is formed on the passivation layer, so that the passivation layer is interposed between the cathode electrode and the second cathode electrode.

(Process 1)

Like the embodiment 1, PD200 was used as a substrate 1 and was sufficiently cleaned. Then, a cathode electrode 2 (a first cathode electrode) made of TiN was formed at the thickness of 500 nm by using a sputtering method (FIG. 12A).

Next, a nickel-carbon mixed film was formed at the thickness of 30 nm by using Co-sputtering (sputtering method) which targets nickel and amorphous carbon. The density of nickel was 4 atomic %.

Then, a surface of the corresponding mixed film was observed by a transmission electron microscope. As a result, even though it was not clear, a carbon layer which contains cobalt nickel particles whose average particle diameter is 3 nm was observed.

Since a nickel particle was not clear, the substrate having the first cathode electrode and the mixed film which were obtained by the above-described process was heated at a vacuum atmosphere at a temperature of 300° C. for one hour and was then cooled down to 80° C. Then, a vacuum was destroyed, and the substrate was exposed to the air until it is cooled down to a room temperature.

After the above treatment, as a result of observing the surface of the mixed film by using a transmission electron microscope, the particles were clearly observed, and the carbon layer containing nickel particles whose average particle diameter is 6 nm was observed.

As a result of observing a chemical bond state of nickel by analyzing a surface of the layer by using an XPS method, a Ni—O bond was observed on the surface. That is, by exposing to the air, the same process as the oxidation process of the process 2 of the embodiment 1 was performed.

(Process 2)

Next, SiO₂ was deposited on the mixed film at the thickness of 50 nm as a passivation layer 121, and TiN was deposited on the passivation layer 121 at the thickness of 50 nm as a second cathode electrode 122. SiO₂ was deposited on the second cathode electrode at the thickness of 1 μm as an insulating layer 7. Pt was deposited on the insulating layer 7 at the thickness of 200 nm as a gate electrode 8 (FIG. 12B).

(Process 3)

Next, a mask pattern of a resist was formed by using a photolithography technique. The gate electrode 8 made of Pt was etched by Ar plasma etching, the insulating layer 7 made of SiO₂ was etched by dry etching using a CF4 gas, and the cathode electrode 122 made of TiN was etched by dry etching using a BCl₃ gas (FIG. 12C) . After etching, the mask pattern was peeled, and cleaning was sufficiently performed. Also, the passivation layer made of SiO₂ was removed by using a buffered fluoric acid (FIG. 12D).

(Process 4)

Next, the device obtained through the processes 1 to 3 was heat-treated in the same way as the embodiment 1 to thereby form a dipole layer 20 on the surface (FIG. 12E.

Through the above-described processes, the electron-emitting device of the embodiment 2 (FIG. 12F) was manufactured.

The electron-emitting device of the embodiment 2 showed the excellent electron-emission characteristic like the embodiment 1. In the embodiment 2, the oxidation process was performed by exposing to the air. The reason that both desired stability and the electron-emission characteristic were obtained by exposing to the air is because nickel is a material which is easy to be oxidized and amorphous carbon is also a material which is easy to be oxidized even though amorphous carbon is intervened, compared to the embodiment 1.

In the embodiment 2, since the passivation layer 121 exists on the electron emitting layer directly before termination, an influence of a peeling solution which occurs in a modified example 1 can be ignored. However, with regard to the abnormal growth of the fiber shown in a modified example 2, the difference is more clearly found than the embodiment 1.

### Embodiment 3

The embodiment 3 is another example of the manufacturing method for the electron-emitting device and is a modified example of the manufacturing method for the embodiment 2.

(Process 1)

Like the embodiment 2, PD200 was used as a substrate 1 and then sufficiently cleaned. Then, a first cathode electrode 2 made of TiN is formed at the thickness of 500 nm by using a sputtering method.

Next, a nickel-carbon mixed film was formed at the thickness of 30 nm by using Co-sputtering (sputtering method) which targets nickel and amorphous carbon. The density of nickel was 4 atomic %.

A surface of the corresponding mixed film was observed by a transmission electron microscope. As a result, even though it was not clear, a carbon layer which contains cobalt nickel particles whose average particle diameter is 3 nm was observed.

(Process 2)

SiO₂ was deposited on the mixed film at the thickness of 50 nm as a passivation layer 121, and TiN was deposited on the passivation layer 121 at the thickness of 50 nm as a second cathode electrode 122. SiO₂ was deposited on the second cathode electrode at the thickness of 1 μm as an insulating layer 7. Pt was deposited on the insulating layer 7 at the thickness of 200 nm as a gate electrode 8.

(Process 3)

Next, a mask pattern of a resist was formed by using a photolithography technique. The gate electrode 8 made of Pt was etched by Ar plasma etching, the insulating layer 7 made of SiO₂ was etched by dry etching using a CF4 gas, and the cathode electrode 122 made of TiN was etched by dry etching using a BCl₃ gas. After etching, the mask pattern was peeled, and cleaning was sufficiently performed. Also, the passivation layer made of Sio₂ was removed by using a buffered fluoric acid.

(Process 4)

Next, the device obtained through the processes 1 to 3 was maintained at an air atmosphere at a temperature of 80° C. for 10 minutes, was then ventilated into a vacuum, and was heated at a temperature of 300° C. for one hour. A methane-hydrogen mixed gas was introduced similarly to the embodiment 1 and was maintained at further increased temperature for one hour. Thereafter, a temperature was cooled down at a gas atmosphere to form a dipole layer 20 on the surface.

Through the above-described processes, the electron-emitting device of the embodiment 3 was manufactured.

In the electron-emitting device of the embodiment 3, a surface of the mixed film was observed by a transmission electron microscope. As a result, metallic particles were clearly observed like the embodiment 2. An electron-emission characteristic of the electron-emitting device of the embodiment 3 was measured. As a result, like the embodiment 2, an excellent electron-emission characteristic was shown.

As described above, the manufacturing method for the electron-emitting device according to the present embodiment can manufacture an electron-emitting device which is stable in the manufacturing process and performs stably an electron emission of high efficiency at a low voltage. Since the electron-emitting device according to the present embodiment can be manufactured by the very simple process described above, an electron-emitting device which emits an electron at a low electric field can be stably manufactured at a relatively low cost and with excellent reproducibility.

### Embodiment 4

The image display apparatus was manufactured by using the electron-emitting device manufactured in the embodiment 1.

The electron source was configured by arranging the electron-emitting devices manufactured in the embodiment 1 in a matrix form of 100×100. The electron-emitting devices were arranged at a pitch of a horizontal 300 μm and a vertical 300 μm. Any of red, blue and green phosphors was arranged above each electron-emitting device.

As a result of line-alternating driving the electron source, an image is displayed, an image display which is high in luminance, high in definition and excellent in contrast was implemented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-320639, filed on Dec. 12, 2007, which is hereby incorporated by reference herein its entirety.

What is claimed is:

1. A manufacturing method of an electron-emitting device comprising the steps of:
preparing a carbon layer containing conductive metallic particles;
oxidizing a portion of the conductive metallic particles; and
forming a dipole layer on a surface of the carbon layer.

2. A manufacturing method of an electron-emitting device according to claim 1, wherein the oxidizing step is a step of exposing the carbon layer containing the conductive metallic particles to an oxidation atmosphere containing oxygen.

3. An electron-emitting device manufactured by the method according to claim 1.

4. An electron source including a plurality of electron-emitting devices according to claim 3.

5. An image display apparatus comprising:
an electron source according to claim 4; and
an image forming member for forming an image by an electron emitted from the electron source.
